(19) United States
(12) Patent Application Publication
(10) Pub. No.: US 2019/0118348 A1
(43) Pub. Date: Apr. 25, 2019

(54) PAIR OF PLIERS WITH WIRE STRIPPING MECHANISM

(71) Applicant: Ying-Ju LIN, Kaohsiung City (TW)

(72) Inventor: Ying-Ju LIN, Kaohsiung City (TW)

(21) Appl. No.: 16/108,021

(22) Filed: Aug. 21, 2018

(30) Foreign Application Priority Data
Oct. 20, 2017 (TW) 106136157

(51) Int. Cl. B25B 7/22; H02G 1/12; B25B 7/02

(52) U.S. Cl. CPC B25B 7/22; B25B 7/02; H02G 1/1212

(57) ABSTRACT

A pair of pliers has a main body with a first lever, a second lever pivotally connected to the first lever, and a wire stripping mechanism. The wire stripping mechanism is mounted to the main body and has two stripping assemblies and an elastic unit. Each one of the two stripping assemblies has a clamping mount, a pinching component, a pivoting pole, and a linkage set. The clamping mount is pivotally connected to the main body. The pinching component is pivotally connected to the clamping mount via the pivoting pole. The linkage set has a linkage unit pivotally connected to the pinching component and one of the first lever and the second lever. The elastic unit is connected to two pivoting poles of the two stripping assemblies. The two stripping assemblies are driven by the first lever and the second lever.

### BACKGROUND OF THE INVENTION

### 1. Field of the Invention

The present invention relates to a hand tool, and more particularly to a pair of pliers capable of wire stripping.

### 2. Description of Related Art

A pair of pliers is a hand tool widely applied to cut cables and to pinch or bend objects. A specialized pair of pliers is even designed for stripping an electrical insulation off a cable.

A conventional pair of pliers has two levers. The two levers are pivotally connected to each other via a shaft. Each one of the two levers has a handle portion and a jaw portion. The jaw portion has a cutting blade and multiple stripping notches. The two cutting blades of the two jaw portions of the two levers are capable of cutting the cable. The multiple stripping notches of the two jaw portions are capable of stripping an electrical insulation of the cable.

However, the conventional pair of pliers may fail to cut the electrical insulation of the cable due to the effort applied to the two handle portions of the two levers is small. The conventional pair of pliers may also damage or cut off a metal wire inside the electrical insulation of the cable when the effort applied to the two handle portions of the two levers is intense.

There are also other pairs of pliers for stripping electrical insulation of wires. However, these pairs of pliers are specialized to strip electrical insulation of wires and cannot be applied to cut wires. A user has to carry two pairs of pliers respectively for cutting wires and for stripping insulation of wires. The conventional pairs of pliers are inconvenient in aspect of portability.

To overcome the shortcomings of the conventional pair of pliers, the present invention provides a pair of pliers with a wire stripping mechanism to mitigate or obviate the aforementioned problems.

### SUMMARY OF THE INVENTION

The main objective of the present invention is to provide a pair of pliers with a wire stripping mechanism that is capable of wire stripping.

The pair of pliers comprises a main body with a first lever and a second lever pivotally connected to the first lever and a wire stripping mechanism. The wire stripping mechanism is mounted to the main body and has two stripping assemblies and an elastic unit. Each one of the two stripping assemblies has a clamping mount, a pinching component, a pivoting pole, and a linkage set. The clamping mount is pivotally connected to the main body. The pinching component is pivotally connected to the clamping mount via the pivoting pole. The linkage set has a linkage unit pivotally connected to the pinching component and one of the first lever and the second lever. The elastic unit is connected to the two pivoting poles of the two stripping assemblies. The two stripping assemblies are driven by the first lever and the second lever.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a pair of pliers in accordance with the present invention;

FIG. 2 is a partially exploded perspective view of the pair of pliers in FIG. 1;

FIG. 3 is a side view of the pair of pliers in FIG. 1;

FIG. 4 is a side view of the pair of pliers in FIG. 1 in partial section;

FIG. 5 is an enlarged side view of the pair of pliers in FIG. 1 in partial section, showing a cable inserted in a wire stripping mechanism of the pair of pliers;

FIG. 6 is another enlarged side view of the pair of pliers in FIG. 1 in partial section, showing the cable being stripped by the wire stripping mechanism;

FIG. 7 is a perspective view of a second embodiment of the pair of pliers in accordance with the present invention;

FIG. 8 is a perspective view of a third embodiment of the pair of pliers in accordance with the present invention;

FIG. 9 is a perspective view of a fourth embodiment of the pair of pliers in accordance with the present invention;

FIG. 10 is a perspective view of a fifth embodiment of the pair of pliers in accordance with the present invention;

FIG. 11 is a perspective view of a sixth embodiment of the pair of pliers in accordance with the present invention; and

FIG. 12 is an enlarged side view of the pair of pliers in FIG. 11, showing the cable inserted in the wire stripping mechanism of the pair of pliers.

### DETAILED DESCRIPTION OF PREFERRED EMBODIMENTS

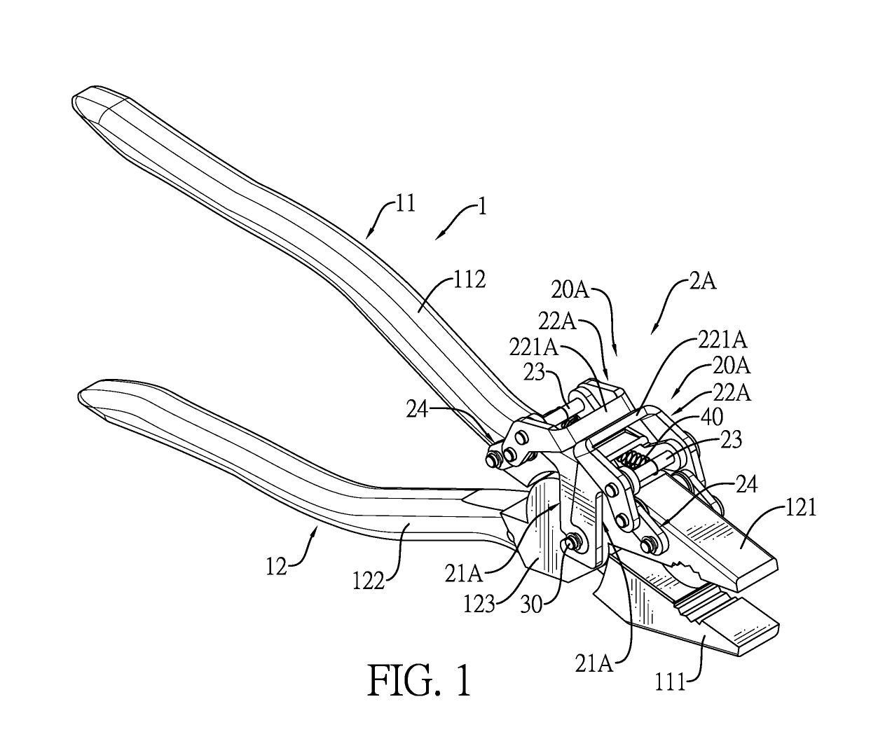

FIGS. 1 and 7 to 11 show a first embodiment, a second embodiment, a third embodiment, a fourth embodiment, a fifth embodiment, and a sixth embodiment of a pair of pliers in accordance with the present invention, respectively. Each one of the six embodiments of the pair of pliers in accordance with the present invention has a main body 1 and a wire stripping mechanism 2A-2F.

The pair of pliers may be slip joint pliers, needle-nose pliers, locking pliers, or other different pliers. With reference to FIGS. 1 and 7 to 11, the main body 1 has a first lever 11, a second lever 12, and a shaft 30. The first lever 11 has a first jaw portion 111, a first handle portion 112, and a first joint portion 113. The first joint portion 113 is disposed between the first jaw portion 111 and the first handle portion 112, and is connected to both the first jaw portion 111 and the first handle portion 112. The second lever 12 has a second jaw portion 121, a second handle portion 122, and a second joint portion 123. The second joint portion 123 is disposed between the second jaw portion 121 and the second handle portion 122, and is connected to both the second jaw portion 121 and the second handle portion 122. The shaft 30 is mounted through the first joint portion 113 and the second joint portion 123 to pivotally connect both the first lever 11 and the second lever 12.

With reference to FIGS. 1 and 7 to 11, the wire stripping mechanism 2A-2F is mounted to the main body 1 and is driven by the first lever 11 and the second lever 12 of the main body 1. The wire stripping mechanism 2A-2F has two stripping assemblies 20A-20F and an elastic unit 40.

With reference to FIGS. 1, 2, and 7 to 11, each one of the two stripping assemblies 20A-20F has a clamping mount 21A-21F, a pinching component 22A-22F, a pivoting pole 23, and a linkage set 24.

The clamping mount 21A-21F has a pivoting end, a clamping end, a clamping board 211A-211F, two side boards 212, 213, a clamping portion 214A-214F, two connected sections 215, an engaging portion 216, and a engaging recess 217. The pivoting end and the clamping end of the clamping mount 21A-21F are opposite each other. The clamping board 211A-211F is disposed at the clamping end of the clamping mount 21A-21F and has two edges. The two side boards 212, 213 are integrally formed on the clamping board 211A-211F with the clamping board 211A-211F located between the two side boards 212, 213. The clamping portion 214A-214F is formed at one of the two edges of the clamping board 211A-211F that is disposed at the clamping end of the clamping mount 21A-21F.

The two connected sections 215 are disposed at the clamping end of the clamping mount 21A-21F, and are integrally formed on the two side boards 212, 213, respectively. The engaging portion 216 is disposed at the pivoting end of the clamping mount 21A-21F, is a disc, and is formed on one of the two side boards 212, 213 of the clamping mount 21A-21F. The engaging recess 217 is disposed at the pivoting end of the clamping mount 21A-21F, is formed in the other one of the two side boards 212, 213 of the clamping mount 21A-21F, and has a round edge.

The two clamping mounts 21A-21F of the two stripping assemblies 20A-20F are pivotally connected to the main body 1. The shaft 30 is mounted through the two pivoting ends of the two clamping mounts 21A-21F. The two clamping ends of the two clamping mounts 21A-21F face to each other. The two clamping portions 214A-214F of the two clamping mounts 21A-21F face to each other.

More specifically, the engaging portion 216 and the engaging recess 217 of one of the two clamping mounts 21A-21F respectively engage with the engaging recess 217 and the engaging portion 216 of the other one of the two clamping mounts 21A-21F. The engaging portion 216 of said one of the two clamping mounts 21A-21F is rotatable relative to the engaging recess 217 of the other one of the two clamping mounts 21A-21F. The shaft 30 is mounted through the two engaging portions 216 and the two engaging recesses 217 of the two clamping mounts 21A-21F.

The pinching component 22A-22F has a linked end, a pinching end, a pinching plate 221A-221F, two arms 222, a pinching portion 223, two middle pivoting portions 224, and two end connecting portions 226. The linked end and the pinching end of the pinching component 22A-22F are opposite to each other. The pinching plate 221A-221F is disposed at the pinching end of the pinching component 22A-22F and has two edges. The two arms 222 are integrally formed on the pinching plate 221A-221F. The pinching plate 221A-221F is disposed between the two arms 222. The pinching portion 223 is formed at one of the two edges of the pinching plate 221A-221F that is disposed at the pinching end of the pinching component 22A-22F. The pinching portion 223 formed at one of the two edges of the pinching plate 221A-221F. The two end connecting portions 226 are disposed at the linked end of the pinching component 22A-22F, and are respectively formed on the two arms 222. The two middle pivoting portions 224 are respectively formed on the two arms 222, and are disposed between the pinching plate 221A-221F and the two end connecting portions 226.

The pivoting pole 23 of one of the stripping assemblies 20A-20F of the two stripping assemblies 20A-20F is parallel to the shaft 30. The pivoting pole 23 of said one stripping assembly 20A-20F is mounted through the two middle pivoting portions 224 of the pinching component 22A-22F of said one stripping assembly 20A-20F and the two connected sections 215 of the clamping mount 21A-21F of said stripping assembly 20A-20F. The clamping mount 21A-21F and the pinching component 22A-22F of said stripping assembly 20A-20F are pivotally connected via the pivoting pole 23 of said stripping assembly 20A-20F. The pinching portion 223 of the pinching component 22A-22F of said stripping assembly 20A-20F is opposite to the clamping portion 214A-214F of the clamping mount 21A-21F of said stripping assembly 20A-20F.

The two pinching components 22A-22F of the two stripping assemblies 20A-20F are pivotally connected to the two clamping mounts 21A-21F of the two stripping assemblies 20A-20F via two pivoting poles 23 of the two stripping assemblies 20A-20F, respectively. The two pinching portions 223 of the two pinching components 22A-22F are opposite each other.

The linkage set 24 of each one of the two stripping assemblies 20A-20F has a linkage unit, a pivoting stick 242, and two pivoting parts 243. The linkage unit has a linking end and a pivoting end. The linking end and the pivoting end of the linkage unit are opposite each other. The linking end of the linkage unit of one of the two stripping assemblies 20A-20F is pivotally connected to the linked end of the pinching component 22A-22F of said stripping assembly 20A-20F.

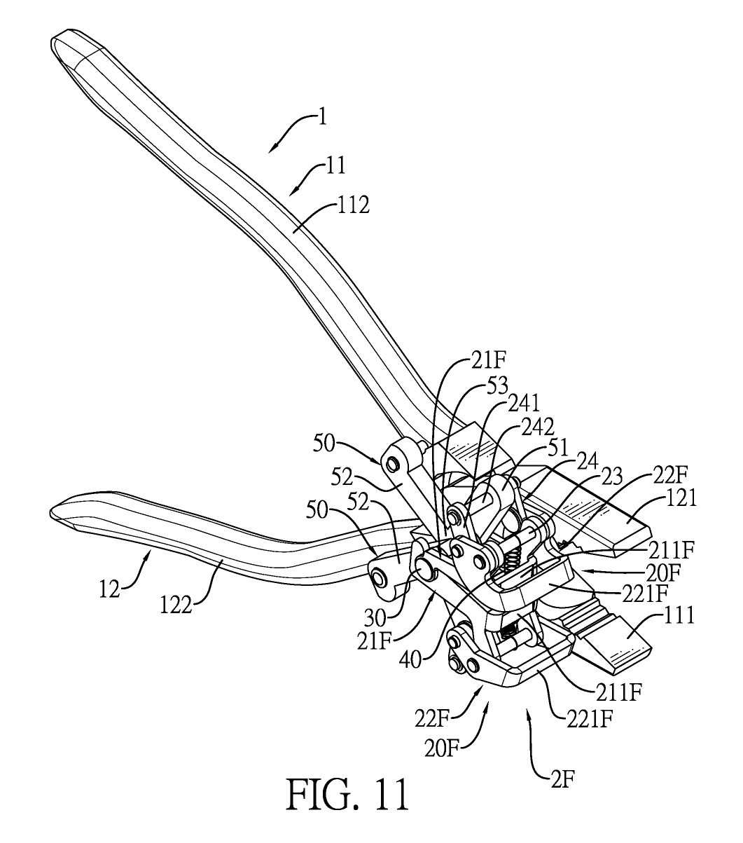

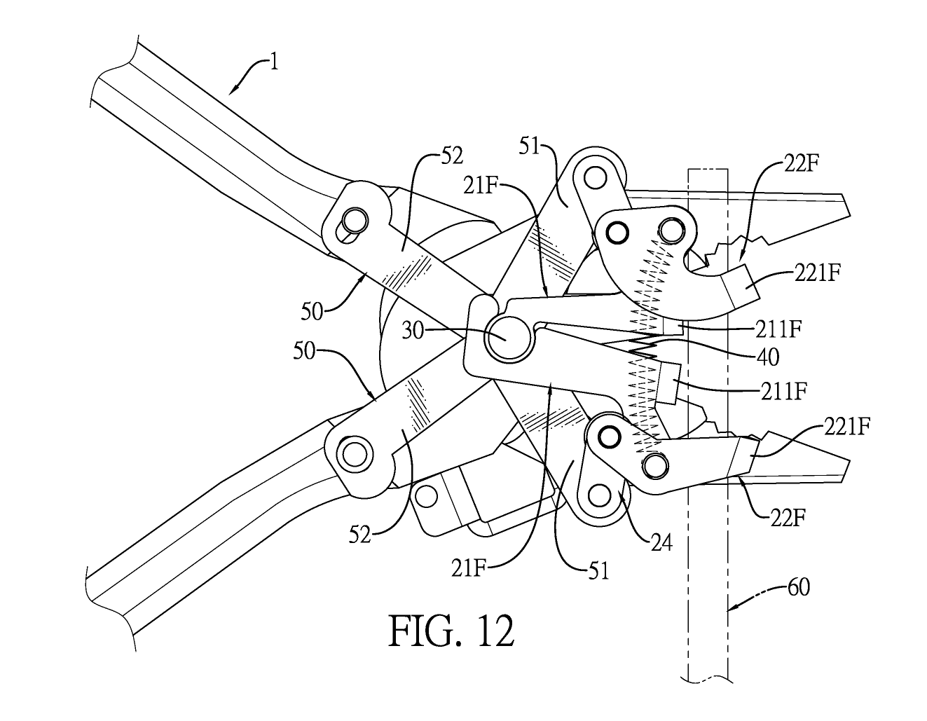

The pivoting stick 242 is mounted through the pivoting end of the linkage unit and the pivoting end is pivotally connected to one of the first lever 11 and the second lever 12 of the main body 1 via the pivoting stick 242. The linkage unit may be directly connected to one of the first lever 11 and the second lever 12 via the pivoting stick 242 mounted through one of the first lever 11 and the second lever 12. The linkage unit may be indirectly connected to one of the first lever 11 and the second lever 12 as shown in FIGS. 11 and 12.

The two pivoting ends of the two linkage units are pivotally connected to the first lever 11 and the second lever 12, respectively.

More specifically, the linkage unit of each one of the two stripping assemblies 20A-20F is two linkage plates 241 respectively mounted through by the two pivoting parts 243. The two linkage plates 241 are pivotally connected to the two end connecting portions 226 of the two arms 222 of the pinching component 22A-22F of said stripping assembly 20A-20F via the two pivoting parts 243 of the linkage set 24, respectively. The pivoting stick 242 of each one of the two linkage sets 24 is mounted through the two linkage plates 241 of the linkage set 24.

The elastic unit 40 has two opposite ends. The two opposite ends of the elastic unit 40 are respectively connected to the two pivoting poles 23. The elastic unit 40 may be an extension spring for providing the two stripping assemblies 20A-20F a force to drag each other.

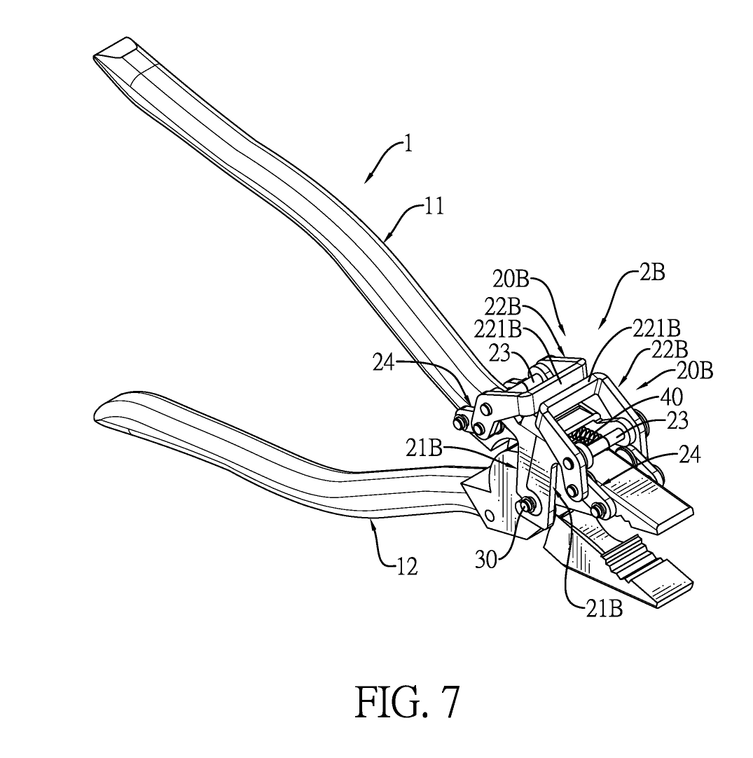

With reference to FIGS. 7, 8, and 10, in the second, the third, and the fifth embodiments, the pinching plate 221B, 221C, 221E of each pinching component 22B, 22C, 22E is perpendicular to the two arms 222.

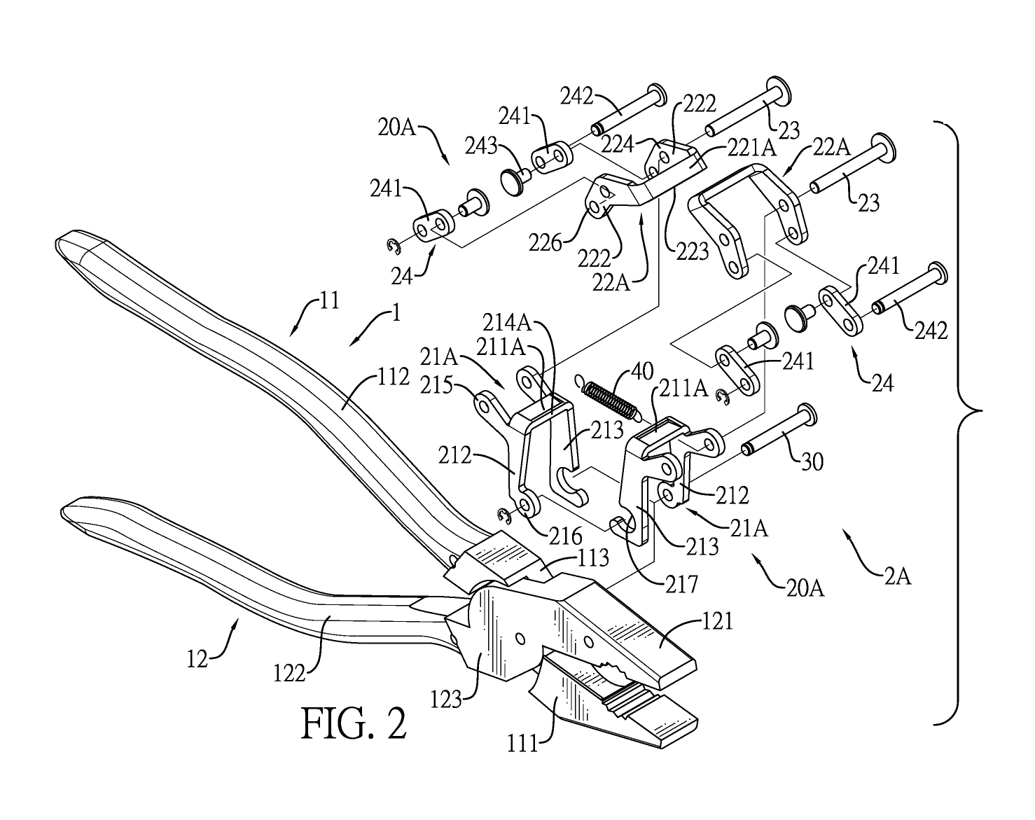

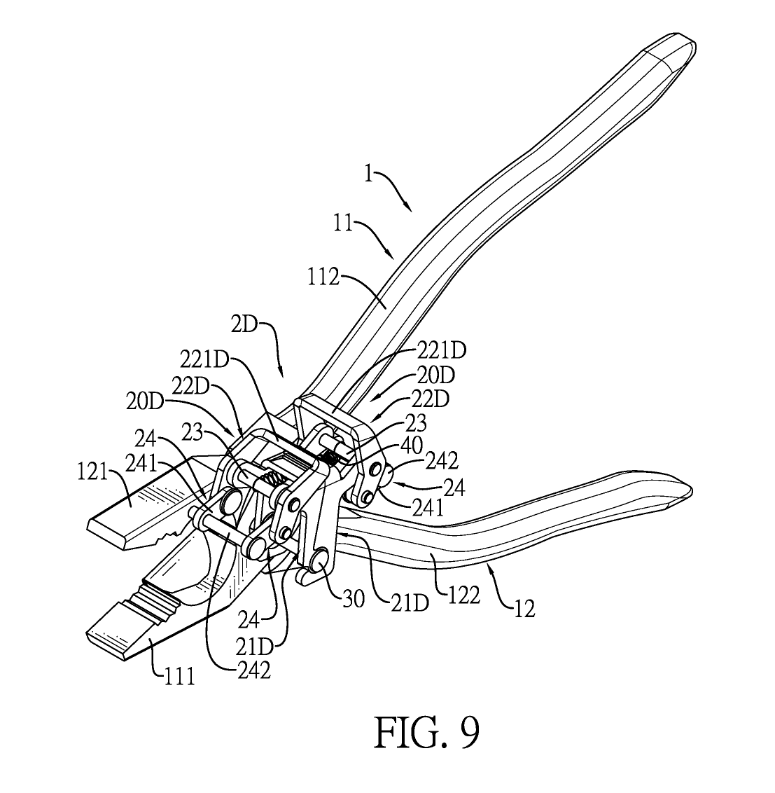

With reference to FIGS. 2 and 9, in the first and the fourth embodiments, the pinching plate 221A, 221D of each pinching component 22A, 22D is inclined relative to the two arms 222.

With reference to FIGS. 2, 7, 9, and 11, in the first, the second, the fourth, and the sixth embodiments, the two pinching portions 223 of the two pinching components 22A, 22B, 22D, 22F are two straight cutting edges.

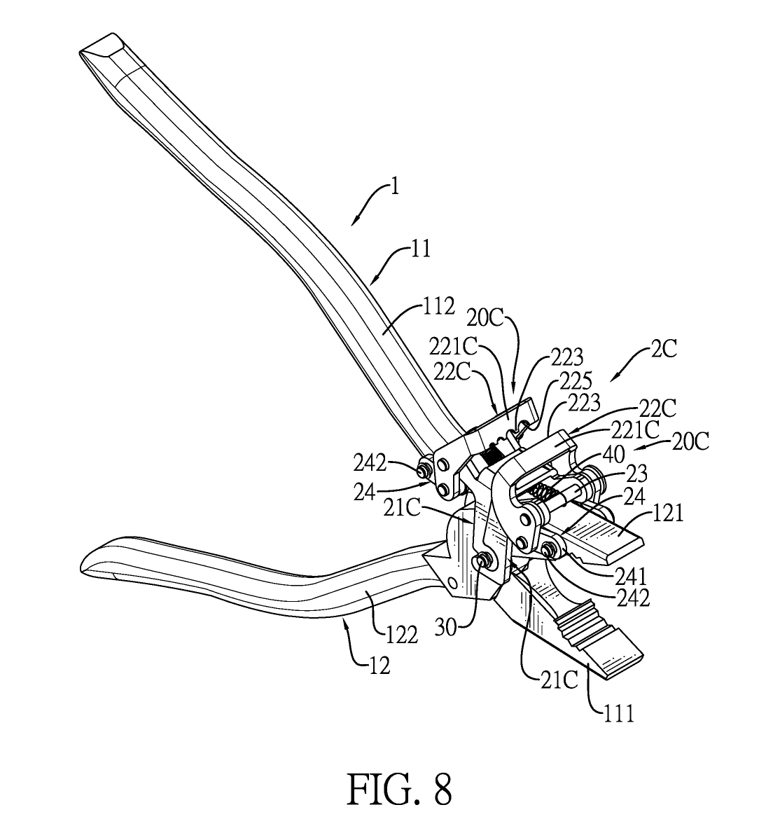

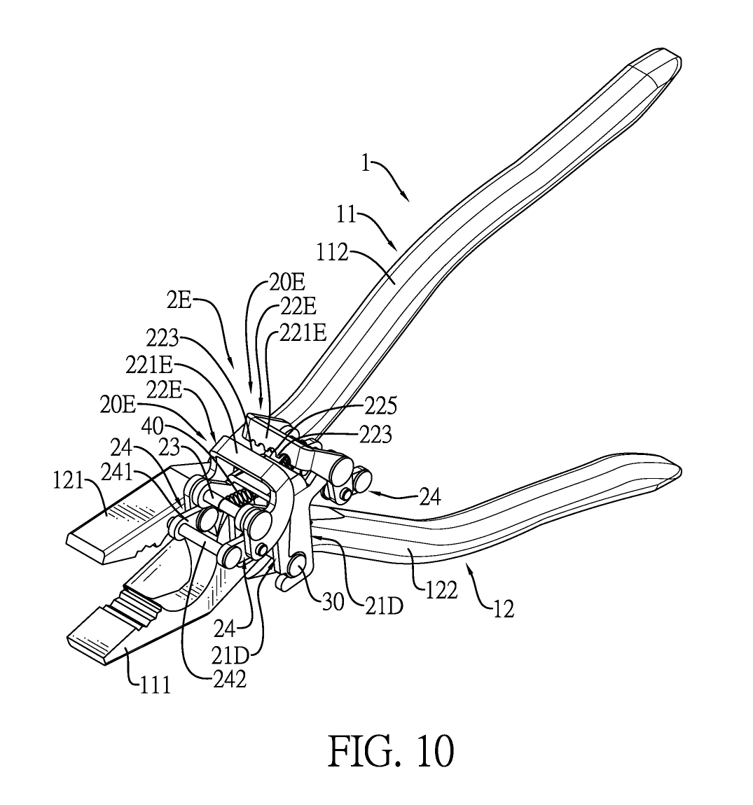

With reference to FIGS. 8 and 10, in the third and fifth embodiments, one of the two pinching components 22C, 22E of the two stripping assemblies 20C, 20E has at least one stripping notch 225. The at least one stripping notch 225 is each a semicircular notch and varies in size for accommodating wires of various diameters.

The wire stripping mechanism 2A-2F may be mounted to the main body 1 in various manners for wire stripping.

With reference to FIGS. 1, 7, and 8, in the first embodiment, the second embodiment, and the third embodiment, the two side boards 212, 213 of the clamping mount 21A, 21B, 21C of each one of the two stripping assemblies 20A, 20B, 20C are respectively disposed beside the first lever 11 and the second lever 12 of the main body 1. The two side boards 212, 213 of the clamping mount 21A, 21B, 21C of each one of the two stripping assemblies 20A, 20B, 20C are pivotally connected to the main body 1 via the shaft 30. The two arms 222 of the pinching component 22A, 22B, 22C of each one of the two stripping assemblies 20A, 20B, 20C are respectively disposed beside the first lever 11 and the second lever 12. The pivoting stick 242 is mounted through the two linkage plates 241 of the linkage unit of the linkage set 24 of one of the two stripping assemblies 20A, 20B, 20C and the two linkage plates 241 are pivotally connected to the second jaw portion 121 of the second lever 12. The two linkage plates 241 of the linkage unit of the linkage set 24 of the other one of the two stripping assemblies 20A, 20B, 20C are also mounted through by the pivoting stick 242 of the linkage set 24 and are pivotally connected to the first handle portion 112 of the first lever 11.

With reference to FIGS. 9 and 10, in the fourth and fifth embodiments, the wire stripping mechanism 2D, 2E is disposed beside either the first lever 11 or the second lever 12 of the main body 1. The pivoting stick 242 of the linkage set 24 of said one of the two stripping assemblies 20D, 20E is mounted through the two linkage plates 241 of the linkage unit of the linkage set 24 in advance and is connected to the second jaw portion 121 of the second lever 12. The pivoting stick 242 of the linkage set 24 of the other one of the two stripping assemblies 20D, 20E is mounted through the two linkage plates 241 of the linkage unit of the linkage set 24 in advance and is connected to the first handle portion 112 of the first lever 11.

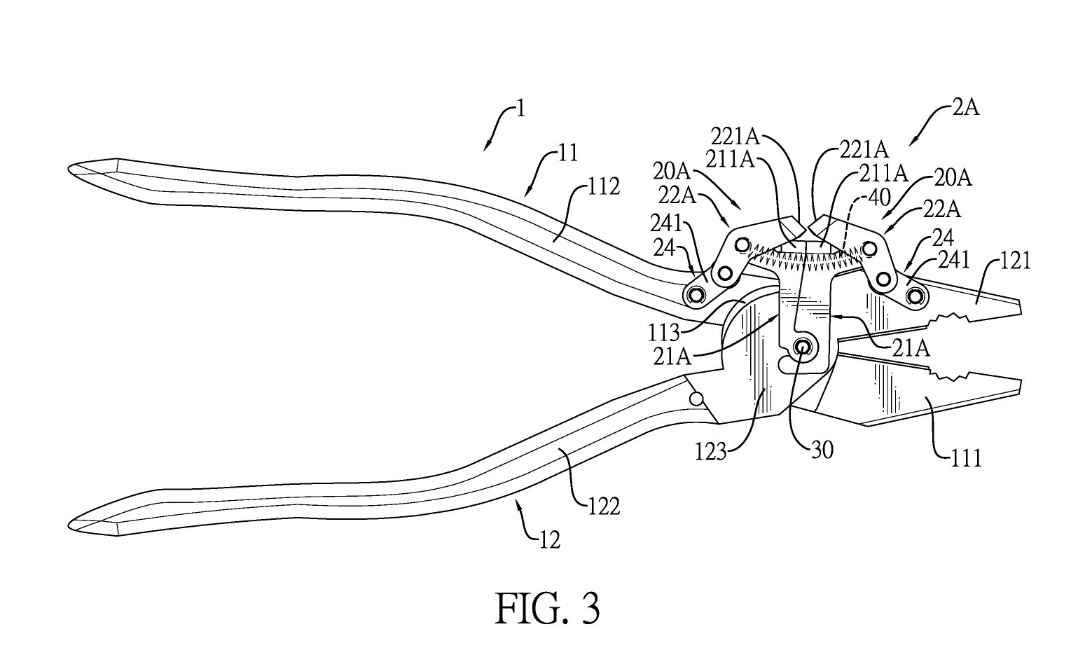

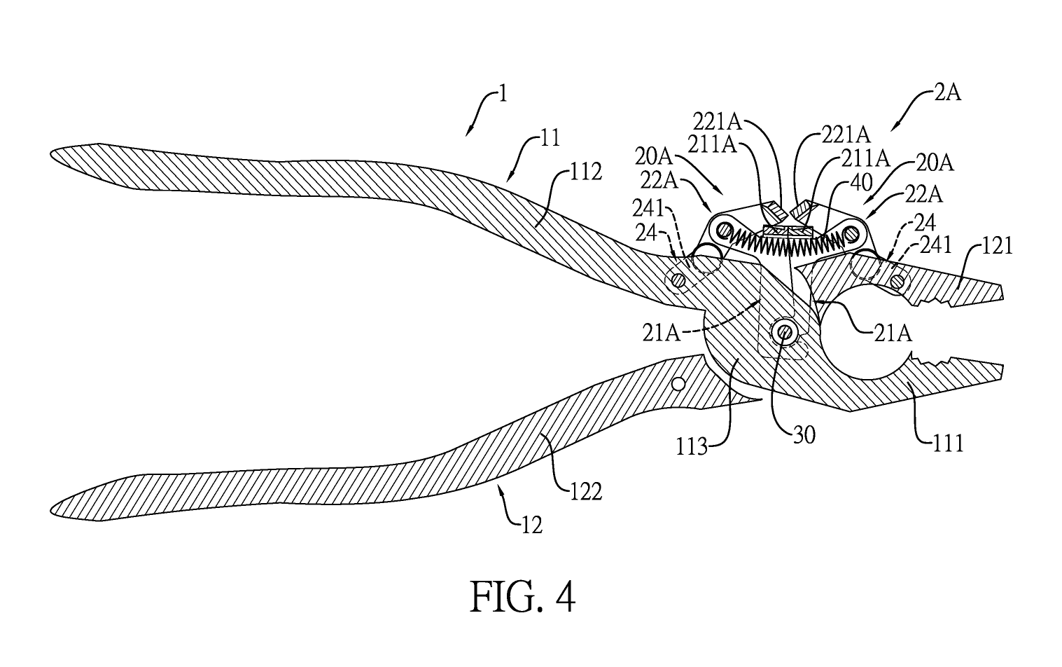

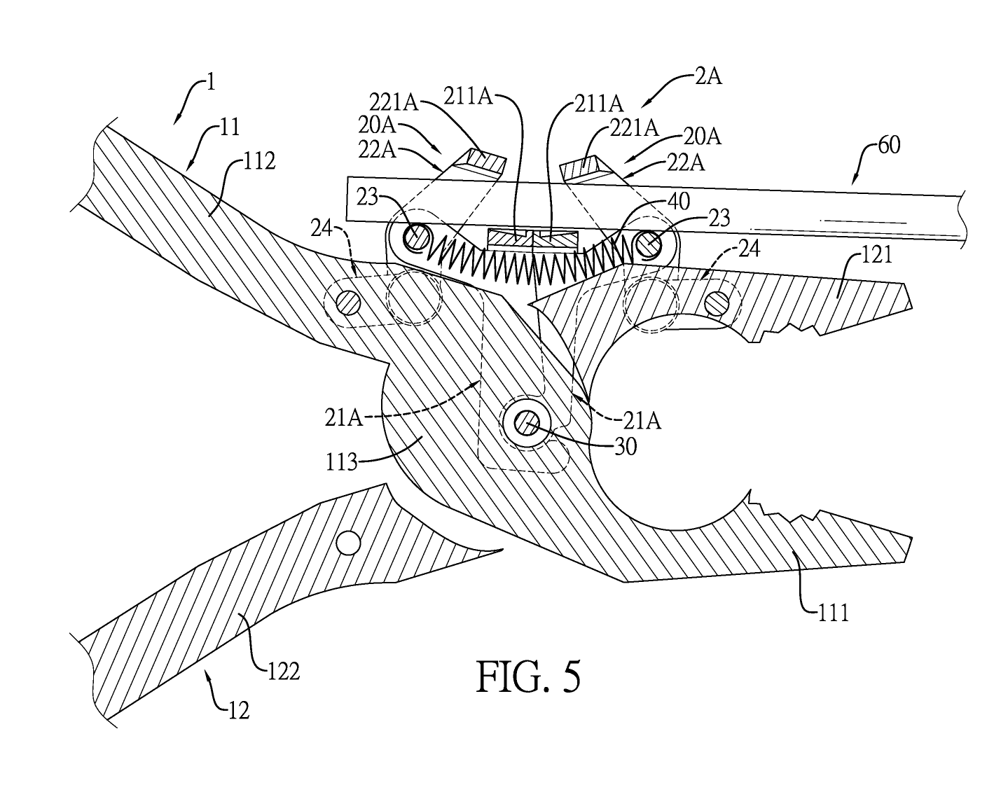

The main body 1 is applied to cut cables and to pinch or bend objects. The wire stripping mechanism 2A-2F is applied to strip electrical insulation from electric wires. The wire stripping mechanism 2A-2F is driven by the first lever 11 and the second lever 12 of the main body 1. With reference to FIGS. 1 to 4, the first embodiment of the pair of pliers is applied to strip a cable 60. With reference to FIG. 5, when the first jaw portion 111 and the second jaw portion 121 open, the clamping mount 21A and the pinching mount 22A of each one of the two stripping assemblies 20A open simultaneously, and the cable 60 is inserted into the clamping mount 21A and the pinching component 22A of each one of the two stripping assemblies 20A.

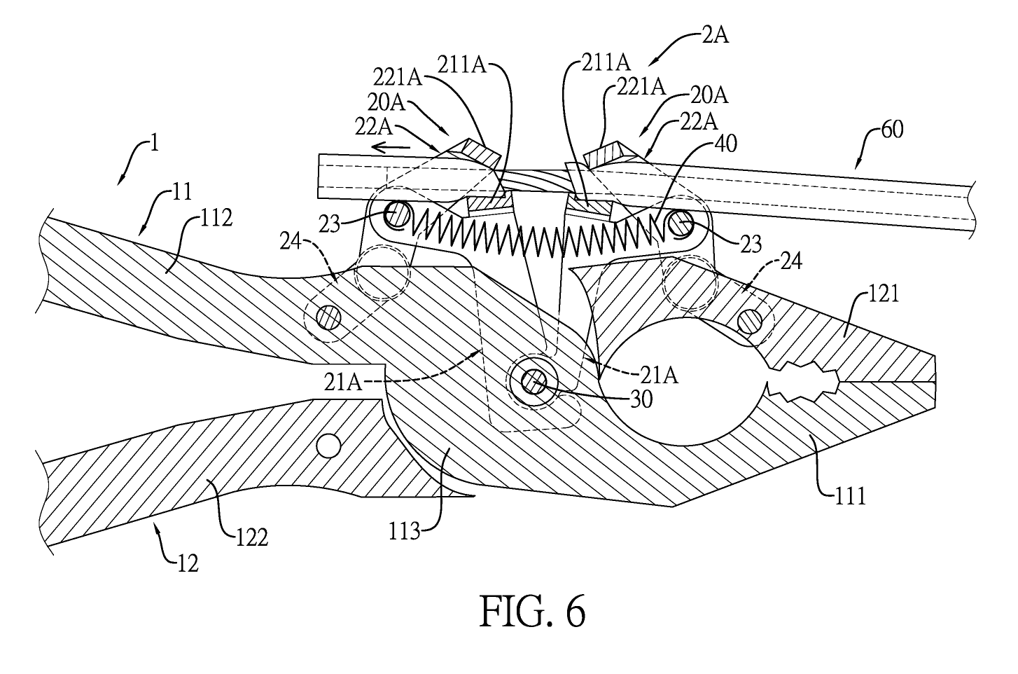

With reference to FIG. 6, when the first handle portion 112 and the second handle portion 122 are gripped and close, the first jaw portion 111 and the second jaw portion 121 close simultaneously. The first handle portion 112 pulls the linkage unit of the linkage set 24 of one of the two stripping assemblies 20A. The second jaw portion 121 pulls the linkage unit of the linkage set 24 of the other one of the two stripping assemblies 20A. The two linkage units respectively drag the two pinching components 22A. The two pinching components 22A respectively rotate with respect to the two pivoting poles 23 and the two pinching plates 221A respectively sweep toward the two clamping boards 211A to clamp the cable 60. The two pinching portions 223 cut an electrical insulation of the cable 60. The two pinching components 22A respectively drag the two clamping mounts 21A respectively via the two pivoting poles 23. The two clamping mounts 21A rotate with respect to the shaft 30 to opposite directions and make the two stripping assemblies 20A move away from each other and rip the cable 60 opposite to strip the cable 60.

When the first handle portion 112 and the second handle portion 122 are loosened, the elastic unit 40 pulls the two stripping assemblies 20A together. The clamping mount 21A and the pinching component 22A of each one of the two stripping assemblies 20A are open to release the cable 60, and the cable 60 may be pulled out from the wire stripping mechanism 2A.

With reference to FIGS. 11 and 12, in the sixth embodiment, the wire stripping mechanism 2F is disposed beside the second lever 12 of the main body 1 and each one of the two stripping assemblies 20F further has a crank arm 50. The crank arm 50 is L-shaped and has a first section 51, a second section 52, a crank pivoting portion 53, a first terminal end, and a second terminal end. The first section 51 and the second section 52 are integrally formed on the crank pivoting portion 53. The first terminal end is disposed at the first section 51. The second terminal end is disposed at the second section 52. The shaft 30 is mounted through the two crank pivoting portions 53 of the two crank arms 50 of the two stripping assemblies 20F, and the two crank pivoting portions 53 are pivotally connected to the main body 1. The two pivoting sticks 242 of the two linkage sets are mounted through the two first terminal ends of the two crank arms 50, respectively. The two first sections 51 of the two crank arms 50 are pivotally connected to the two linkage units of the two linkage sets 24, respectively. The two second terminal ends of the two crank arms 50 are pivotally connected to the first handle portion 112 and the second handle portion 122, respectively. The two linkage units are indirectly connected to the first lever 11 and the second lever 12 via the two crank arms 50.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pair of pliers comprising:
a main body having
a first lever having a first jaw portion and a first handle portion;
a first joint portion disposed between the first jaw portion and the first handle portion and connected to both the first jaw portion and the first handle portion;
a second lever having a second jaw portion, a second handle portion, and a second joint portion disposed between the second jaw portion and the second handle portion and connected to both the second jaw portion and the second handle portion; and
a shaft mounted through the first joint portion and the second joint portion to pivotally connect both the first lever and the second lever;
a wire stripping mechanism mounted to the main body, driven by the first lever and the second lever, and having
two stripping assemblies;
each one of the two stripping assemblies having
a clamping mount having
a pivoting end;
a clamping end opposite to the pivoting end of the clamping mount;
a clamping portion disposed at the clamping end of the clamping mount;
the shaft mounted through the pivoting end of the clamping mount and the pivoting end pivotally connected to the first lever via the shaft;
a pinching component having
a linked end;
a pinching end opposite to the linked end of the pinching component; and
a pinching portion disposed at the pinching end of the pinching component; and
a pivoting pole disposed parallel to the shaft and mounted through the clamping end of the clamping mount and the pinching component;
the clamping mount and the pinching component pivotally connected via the pivoting pole; and
a linkage set having
a linkage unit having
a linking end pivotally connected to the linked end of the pinching component;
a pivoting end disposed opposite to the linking end of the linkage component;
the two pivoting ends of the two linkage units of the two linkage sets of the two stripping assemblies pivotally connected to the first lever and the second lever, respectively; and
an elastic unit having two opposite ends respectively connected to the two pivoting poles of the two stripping assemblies; wherein
the shaft is disposed between the two pivoting ends of the two linkage units; and
the two clamping ends of the two clamping mounts face to each other.

2. The pair of pliers as claimed in claim 1, wherein
the clamping mount of each one of the two stripping assemblies has
two side boards respectively disposed beside the first lever and the second lever; and
two connected sections disposed at the clamping end of the clamping mount and integrally formed on the two side boards, respectively;
the clamping portion of the clamping mount is disposed between the two side boards of the clamping mount;
the two side boards of the clamping mount of each one of the two stripping assemblies are pivotally connected to the main body via the shaft;
the pinching component of each one of the two stripping assemblies has
two arms respectively disposed beside the first lever and the second lever;
the pinching portion of the pinching component is disposed between the two arms of the pinching component;
the two arms of the pinching component of each one of the two stripping assemblies are mounted through by the pivoting pole of said one of the two stripping assemblies and pivotally connected to the two connected sections of the clamping mount of said one of the two stripping assemblies;
the pivoting end of one of the two linkage units is connected to the second jaw portion of the second lever;
the pivoting end of the other one of the two linkage units is connected to the first handle portion of the first lever;
each one of the two linkage units is two linkage plates pivotally connected to the two arms of the pinching component of said one of the two stripping assemblies, respectively.

3. The pair of pliers as claimed in claim 1, wherein
the wire stripping mechanism is disposed beside one of the first lever and the second lever;
each of the two linkage sets has a pivoting stick mounted through the pivoting end of the linkage unit of the linkage set;
the two pivoting sticks of the two linkages sets are respectively connected to the first jaw portion of the first lever and the second handle portion of the second lever.

4. The pair of pliers as claimed in claim 1, wherein
each one of the two stripping assemblies has a crank arm being L-shaped and having
a first terminal end; and
a second terminal end;
the shaft is mounted through the two crank arms of the two stripping assemblies;
the two first terminal ends of the two crank arms are pivotally connected to the two pivoting ends of the two linkage units, respectively;
the two second terminal ends of the two crank arms are pivotally connected to the first handle portion of the first lever and the second handle portion of the second lever, respectively.

5. The pair of pliers as claimed in claim 1, wherein
the clamping mount of each one of the two stripping assemblies has
an engaging portion disposed at the pivoting end of the clamping mount, being a disc, and formed on one of the two side boards of the clamping mount; and
an engaging recess disposed at the pivoting end of the clamping mount, formed in the other one of the two side boards of the clamping mount, and having a round edge;
the engaging portion and the engaging recess of one of the two clamping mounts respectively engage with the engaging recess and the engaging portion of the other one of the two clamping mounts;
the engaging portion of said one of the two clamping mounts is rotatable relative to the engaging recess of the other one of the two clamping mounts; and
the shaft is mounted through the two engaging portions and the two engaging recesses of the two clamping mounts.

6. The pair of pliers as claimed in claim 2, wherein
the clamping mount of each one of the two stripping assemblies has
an engaging portion disposed at the pivoting end of the clamping mount, being a disc, and formed on one of the two side boards of the clamping mount; and
an engaging recess disposed at the pivoting end of the clamping mount, formed in the other one of the two side boards of the clamping mount, and having a round edge;
the engaging portion and the engaging recess of one of the two clamping mounts respectively engage with the engaging recess and the engaging portion of the other one of the two clamping mounts;
the engaging portion of said one of the two clamping mounts is rotatable relative to the engaging recess of the other one of the two clamping mounts; and
the shaft is mounted through the two engaging portions and the two engaging recesses of the two clamping mounts.

7. The pair of pliers as claimed in claim 3, wherein
the clamping mount of each one of the two stripping assemblies has
an engaging portion disposed at the pivoting end of the clamping mount, being a disc, and formed on one of the two side boards of the clamping mount; and
an engaging recess disposed at the pivoting end of the clamping mount, formed in the other one of the two side boards of the clamping mount, and having a round edge;
the engaging portion and the engaging recess of one of the two clamping mounts respectively engage with the engaging recess and the engaging portion of the other one of the two clamping mounts;
the engaging portion of the one of the two clamping mounts is rotatable relative to the engaging recess of the other one of the two clamping mounts; and
the shaft is mounted through the two engaging portions and the two engaging recesses of the two clamping mounts.

8. The pair of pliers as claimed in claim 4, wherein
the clamping mount of each one of the two stripping assemblies has
an engaging portion disposed at the pivoting end of the clamping mount, being a disc, and formed on one of the two side boards of the clamping mount; and
an engaging recess disposed at the pivoting end of the clamping mount, formed in the other one of the two side boards of the clamping mount, and having a round edge;
the engaging portion and the engaging recess of one of the two clamping mounts respectively engage with the engaging recess and the engaging portion of the other one of the two clamping mounts;
the engaging portion of said one of the two clamping mounts is rotatable relative to the engaging recess of the other one of the two clamping mounts; and
the shaft is mounted through the two engaging portions and the two engaging recesses of the two clamping mounts.

9. The pair of pliers as claimed in claim 5, wherein the two pinching portions of the two pinching components of the two stripping assemblies are two straight cutting edges.

10. The pair of pliers as claimed in claim 6, wherein the two pinching portions of the two pinching components of the two stripping assemblies are two straight cutting edges.

11. The pair of pliers as claimed in claim 7, wherein the two pinching portions of the two pinching components of the two stripping assemblies are two straight cutting edges.

12. The pair of pliers as claimed in claim 8, wherein the two pinching portions of the two pinching components of the two stripping assemblies are two straight cutting edges.

13. The pair of pliers as claimed in claim 5, wherein one of the two pinching portions of the two pinching components of the two stripping assemblies has at least one stripping notch.

14. The pair of pliers as claimed in claim 6, wherein one of the two pinching portions of the two pinching components of the two stripping assemblies has at least one stripping notch.

15. The pair of pliers as claimed in claim 7, wherein one of the two pinching portions of the two pinching components of the two stripping assemblies has at least one stripping notch.

16. The pair of pliers as claimed in claim 8, wherein one of the two pinching portions of the two pinching components of the two stripping assemblies has at least one stripping notch.

17. The pair of pliers as claimed in claim 13, wherein the at least one stripping notch is each a semicircular notch and varies in size.

18. The pair of pliers as claimed in claim 14, wherein the at least one stripping notch is each a semicircular notch and varies in size.

19. The pair of pliers as claimed in claim 15, wherein the at least one stripping notch is each a semicircular notch and varies in size.

20. The pair of pliers as claimed in claim 16, wherein the at least one stripping notch is each a semicircular notch and varies in size.
